(19) United States
(12) Patent Application Publication
(10) Pub. No.: US 2012/0093536 A1
(43) Pub. Date: Apr. 19, 2012

(54) IMAGE FORMING SYSTEM

(75) Inventor: Masayuki ITO, Nagoya-shi (JP)

(73) Assignee: KONICA MINOLTA BUSINESS TECHNOLOGIES INC., Tokyo (JP)

(21) Appl. No.: 13/268,026

(22) Filed: Oct. 7, 2011

(30) Foreign Application Priority Data
Oct. 13, 2010 (JP) 2010-230182

(51) Int. Cl. G03G 15/00

(52) U.S. Cl. 399/82

(57) ABSTRACT

An image forming system of a series-connected tandem configuration includes a plurality of image forming apparatuses connected in series, and when a job in a both-side mode in which images are formed on both sides of a sheet is executed, one of the image forming apparatuses forms an image on one side of the sheet, and an image forming apparatus different from the image forming apparatus forming the image on the one side forms an image on the other side of the sheet. The image forming system comprising a control section for managing execution of a job of each of the image forming apparatuses, receiving an execution reservation of each of a plurality of jobs, managing the received jobs as reservation jobs, selecting a reservation job for which the image forming apparatuses operate concurrently among the reservation jobs, and preferentially executing the selected reservation job.

### BACKGROUND

1. Field of the Invention

The present invention relates to an image forming system.

2. Description of Related Art

In an image forming system having a tandem configuration in which a plurality of image forming apparatuses are connected in series by connecting sheet conveying paths, there has been a need to improve overall execution efficiency of a plurality of jobs to be executed continuously to improve productivity.

Japanese Patent Application Laid-Open Publication No. 2005-22243 discloses a technique to, in an image forming system having a tandem configuration including two image forming apparatuses and a discharge apparatus disposed between the two image forming apparatuses, use one of the image forming apparatuses in a case of a job in a single-side mode in which an image is formed on a single side of a sheet, and make one of the image forming apparatuses form an image on a surface of a sheet and then make the other of the image forming apparatuses form an image on the back surface of the sheet in a case of a job in a both-side mode in which images are formed on both sides of a sheet. According to whether the mode is the single-side mode or the both-side mode, the conveying path of the discharge apparatus is switched.

Moreover, Japanese Patent Application Laid-Open Publication No. H8-319051 discloses a technique to provide a configuration in which multiple stages of printers each having a print member and a feeding member to feed sheets to the print member are arranged in the vertical direction, and the printers are connected via sheet conveying paths, and close/open the sheet conveying paths according to whether a mode is the single-side mode or both-side mode.

Furthermore, Japanese Patent Application Laid-Open Publication No. 2009-139732 discloses a technique to, in one image forming apparatus, determine whether a conveying path of sheets is switched between a currently-executed job and a waiting job, and determines an execution order such that a job which does not require switching of the conveying path is preferentially executed so as to reduce the switching frequency of the conveying path. This prevents reduction of the overall processing efficiency of a plurality of jobs.

However, when using the image forming system according to the technique disclosed in Japanese Patent Application Laid-Open Publication No. 2005-22243 or Japanese Patent Application Laid-Open Publication No. H8-319051, since a plurality of jobs are sequentially executed when continuously executing the jobs, some of the image forming apparatuses are in waiting state and it takes much time to complete execution of all of the jobs. Meanwhile, though the image forming apparatus according to Japanese Patent Application Laid-Open Publication No. 2009-139732 uses the technique to change the execution order of the jobs when the jobs are executed by one image forming apparatus in order to solve the problem of reduction of the processing efficiency caused by switching of the conveying path, this technique is not intended to solve the problem of reduction of the processing efficiency caused by image forming apparatuses made into waiting state when a plurality of jobs are executed by a plurality of image forming apparatuses.

### SUMMARY

The present invention is made in view of the above circumstances, and it is an object of the present invention to improve overall execution efficiency of a plurality of jobs to improve productivity.

In order to achieve at least one of the above-mentioned objects, an image forming system in which one aspect of the present invention is reflected is an image forming system of a series-connected tandem configuration including a plurality of image forming apparatuses connected in series, in which when a job in a both-side mode in which images are formed on both sides of a sheet is executed, one of the image forming apparatuses forms an image on one side of the sheet, and an image forming apparatus different from the image forming apparatus forming the image on the one side forms an image on the other side of the sheet, the image forming system comprising: a control section for managing execution of a job of each of the image forming apparatuses, receiving an execution reservation of each of a plurality of jobs, managing the received jobs as reservation jobs, selecting a reservation job for which the image forming apparatuses operate concurrently among the reservation jobs, and preferentially executing the selected reservation job.

Preferably, the control section selects, as a preferentially executed reservation job, a reservation job for which an image forming apparatus in waiting state among the image forming apparatuses matches an image forming apparatus capable of executing the reservation job determined based on output mode information indicating either a single-side mode in which an image is formed on a single side of the sheet or the both-side mode, and based on finishing presence/absence information indicating whether finishing is set for the sheet on which the image is already formed, the output mode information and the finishing presence/absence information being set in the reservation job.

Preferably, the control section manages the reservation jobs by attaching date/time information at which the execution reservation is received for each of the reservation jobs, and when there is a skipped job, in the reservation jobs, whose execution order is skipped so that a reservation job whose reception date/time is later than the reception date/time of the skipped job is executed prior to the skipped job, and when the skipped job is a job in the both-side mode, the skipped job is selected as the preferentially executed reservation job by interrupting a currently-executed job.

Preferably, when there is an image forming apparatus, in the image forming apparatuses, in which execution of a job in a single-side mode is finished, the control section selects the skipped job as the preferentially executed reservation job.

Preferably, the image forming system further comprising a memory section for storing a reservation job management table for managing information related to each of the reservation jobs and execution job management data for managing a job executed in each of the image forming apparatuses.

Preferably, one of the image forming apparatuses has the control section and the memory section.

### BRIEF DESCRIPTION OF THE DRAWINGS

The present invention will become more fully understood from the detailed description given hereinbelow and the appended drawings, and thus are not intended as a definition of the limits of the present invention, and wherein:

FIG. 1 is a schematic configuration diagram showing an image forming system;

FIG. 2 is a schematic configuration diagram showing a first image forming apparatus;

FIG. 3 is a diagram showing an example of a reservation job management table;

FIGS. 4A-4C are diagrams each showing an example of execution job management data;

FIG. 5 is a schematic configuration diagram showing a second image forming apparatus;

FIG. 6 is a flowchart of job reception processing;

FIG. 7 is a main flowchart of job selection processing;

FIG. 8 is a flowchart of execution job determination processing; and

FIG. 9 is a flowchart of skipped job execution processing.

### DETAILED DESCRIPTION OF THE PREFERRED EMBODIMENT

Hereinafter, embodiments of the present invention will be described in detail with reference to the drawings.

First, a configuration will be described.

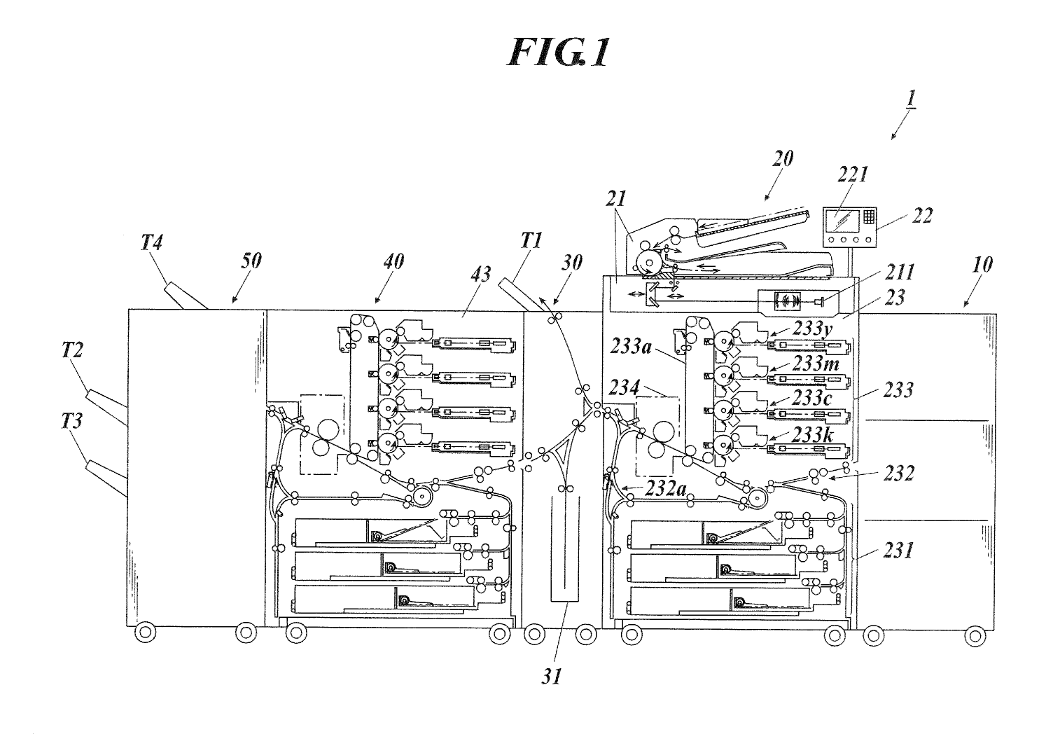

FIG. 1 shows a schematic configuration diagram of an image forming system 1 according to the present embodiment.

As shown in FIG. 1, an image forming system 1 has a series-connected tandem configuration including a feeding apparatus 10, a first image forming apparatus 20, a reversing apparatus 30, a second image forming apparatus 40, and a finishing apparatus 50, which are connected in series from the upstream side of the conveying path of sheets.

In the image forming system according to the present embodiment, each of the first image forming apparatus 20 and the second image forming apparatus 40 forms an image on a single side of a sheet. When executing a job of a both-side mode in which images are formed on both sides of a sheet, the first image forming apparatus 20 operates to form an image on one side of the sheet (for example, front surface), and the second image forming apparatus 40 operates to form an image on the other side of the sheet (for example, back surface).

The feeding apparatus 10 is referred to as a Paper Feed Unit (PFU), and includes a plurality of feeding trays and feeding members each including a feeding roller, a separation roller, a feeding/separation rubber, a feed-out roller, and so on. Each of the feeding trays stores sheets distinguished in advance according to each type of sheet (sheet type, basis weight, sheet size, and the like), and the sheets are conveyed one by one, with the uppermost sheet conveyed first, by each of the feeding members to a sheet conveying section of the first image forming apparatus.

The first image forming apparatus 20 reads an image from an original document to form the read image on a sheet, or receives print setting data and print data of a format such as Page Description Language (PDL) format and Tagged Image File Format (Tiff) format from an external apparatus and the like to form an image on a sheet based on the received print setting data and print data. The first image forming apparatus 20 includes an image reading section 21, an operation display section 22, a print section 23, and the like.

The image reading section 21 has an auto original document feeding section referred to as an Auto Document Feeder (ADF) and a reading section, and reads images of a plurality of original documents based on the setting information received by the operation display section 22. The original documents stacked on the original document tray of the auto original document feeding section are conveyed to a contact glass serving as a reading portion, an image/images on the single side or both sides of the original document is read by an optical system, and a Charge Coupled Device (CCD) 211 reads the image/images of the original document. In this case, the image/images are meant to include not only image data such as figures and pictures but also text data such as characters and symbols.

The operation display section 22 includes a Liquid Crystal Display (LCD) 221, a touch panel arranged to cover the LCD 221, various types of switches and buttons, a numeric keypad, an operation key group, and so on. The operation display section 22 receives a command from a user to output an operation signal thereof to a control section 250 described below, and displays various setting screens for inputting various operation commands and setting information, and various processing results, and the like, according to a display signal input from the control section 250.

The print section 23 performs electrophotographic image formation processing, and includes sections related to print output, i.e., a feeding section 231, a sheet conveying section 232, an image forming section 233 for each color, and a fixing section 234.

In the present embodiment, an example in which electrophotographic is applied to the print section 23 is described, but the print section 23 is not limited thereto. Alternatively, other print methods such as an inkjet method, and a thermal sublimation method, may be employed.

The feeding section 231 includes a plurality of feeding trays, and feeding members arranged for the respective feeding trays. Each of the feeding members including a feeding roller, a separation roller, a feeding/separation rubber, a feed-out roller, and the like. Each of the feeding trays stores sheets distinguished in advance according to each type of sheet (sheet type, basis weight, sheet size, and the like), and the sheets are conveyed one by one, with the uppermost sheet conveyed first, by the feeding member to the sheet conveying section.

The sheet conveying section 232 conveys the sheets from the feeding apparatus 10 or feeding section 231 to the sheet conveying path through a plurality of intermediate rollers, registration rollers, and the like to the image forming section 233, to convey the sheets to a secondary transfer position of the image forming section 233.

The sheet conveying section 232 includes a reversing conveying section 232a. The reversing conveying section 232a makes a sheet discharged from the fixing section 234 turn back using a reversing roller, thereby reversing the front side and the back side of the sheet and conveying the sheet to the reversing apparatus 30.

The image forming section 233 includes a photosensitive drum, a charging device, an exposure device, a developing device, a primary transfer roller, a cleaning device and the like, and produces an output matter, i.e., a sheet on which an image is formed based on print image data. When the first image forming apparatus 20 is a type that forms color images, the image forming section 233 is provided for each color.

In an image forming section 233y for forming an image in yellow (Y), light according to print image data of yellow (Y) is emitted from the exposure device onto the surface of the photosensitive drum charged by the charging device, and thus an electrostatic latent image is written thereto. Then, the developing device causes charged toner of yellow (Y) to attach onto the surface of the photosensitive drum to which the electrostatic latent image is written, whereby the electrostatic latent image is developed. The photosensitive drum rotates with a constant velocity, so that the toner attached onto the photosensitive drum by the developing device is transferred to an intermediate transfer belt 233a at a primary transfer position at which a primary transfer roller is arranged. After the toner is transferred to the intermediate transfer belt 233a, a cleaning device removes residual charges, residual toners, and the like remaining on the surface of the photosensitive drum, and the removed toner and the like are collected in a toner collection box.

Likewise, each of image forming sections 233m, 233c, 233k for respective colors includes a charging device, an exposure device, a developing device, a primary transfer roller, a cleaning device, and the like arranged around a photosensitive drum, and the image forming sections 233m, 233c, 233k form toner images in magenta (M), cyan (C), black (K), respectively.

The toner images of the respective colors transferred to the intermediate transfer belt 233a are collectively transferred to the sheet at a secondary transfer position at which a secondary transfer roller is arranged.

The fixing section 234 includes a fixing heater, a fixing roller, a fixing external heating section, and the like, and is configured to heat and fix the toner image transferred to the sheet.

The sheet to which fixing processing has been performed by the fixing section 234 is conveyed to the reversing apparatus 30 by the discharge roller and the like. Alternatively, it is conveyed to the reversing conveying section 232a of the sheet conveying section 232.

The reversing apparatus 30 includes a stacker 31 and the like having a discharge tray T1, a reversing roller, and the like, and is disposed between the first image forming apparatus 20 and the second image forming apparatus 40.

According to the command from the first image forming apparatus, the reversing apparatus 30 conveys the sheet, on the single side of which an image is formed by the first image forming apparatus 20, to the second image forming apparatus 40, or discharges it to the discharge tray T1. When it is necessary to reverse the front/back sides of the sheet to be conveyed to the second image forming apparatus 40, the sheet is turned back by the reversing roller and the like provided in the stacker 31, so that the front/back sides of the sheet are reversed, and the reversed sheet is conveyed to the second image forming apparatus 40.

The second image forming apparatus 40 is configured to include a print section 43 and the like, and according to the command from the first image forming apparatus 20, the second image forming apparatus 40 forms an image on the single side of the sheet.

It should be noted that the print section 43 provided in the second image forming apparatus 40 has the same configuration as the print section 23 provided in the first image forming apparatus 20, and accordingly, description thereabout will not be repeated.

The finishing apparatus 50 includes various finishing units such as a reversing unit, a sorting unit, a staple unit, a punch unit, and a folding unit, and a plurality of discharge trays T2 to T4. The finishing apparatus 50 performs various finishing processes on sheets conveyed from the second image forming apparatus 40 according to the command from the first image forming apparatus 20, and discharges the sheets to which the finishing processes have been executed to any one of the discharge trays T2 to T4.

When the first image forming apparatus 20 executes a job in a single-side mode, the image forming system 1 according to the present embodiment discharges a sheet to the discharge tray T1. When the second image forming apparatus 40 executes a job in the single-side mode, the image forming system 1 according to the present embodiment discharges a sheet to the discharge tray T2. Further, when a job is executed in the both-side mode, a sheet is discharged to the discharge tray T3.

However, the discharge trays are not limited thereto. When the first image forming apparatus 20 executes a job in the single-side mode, sheets on the stacker 31 of the reversing apparatus 30 may be temporarily stored, and the stacker 31 may be used as a discharge tray. Alternatively, a sheet conveying path may be arranged from the conveyance port of the first image forming apparatus through the reversing apparatus 30, the second image forming apparatus 40, and the finishing apparatus 50, and the discharge tray T4 may be arranged at the exit of the sheet conveying path, so that when the first image forming apparatus 20 executes a job in the single-side mode, the discharge tray T4 may be used as a discharge tray to which the sheet is discharged.

In the present embodiment, the first image forming apparatus 20 including the image reading section 21, the operation display section 22, and a controller 24 is provided upstream of the second image forming apparatus 40 in the sheet conveying path of the image forming system 1. However, the arrangement is not limited thereto. The first image forming apparatus 20 and the second image forming apparatus 40 may be arranged at opposite positions from the above arrangement.

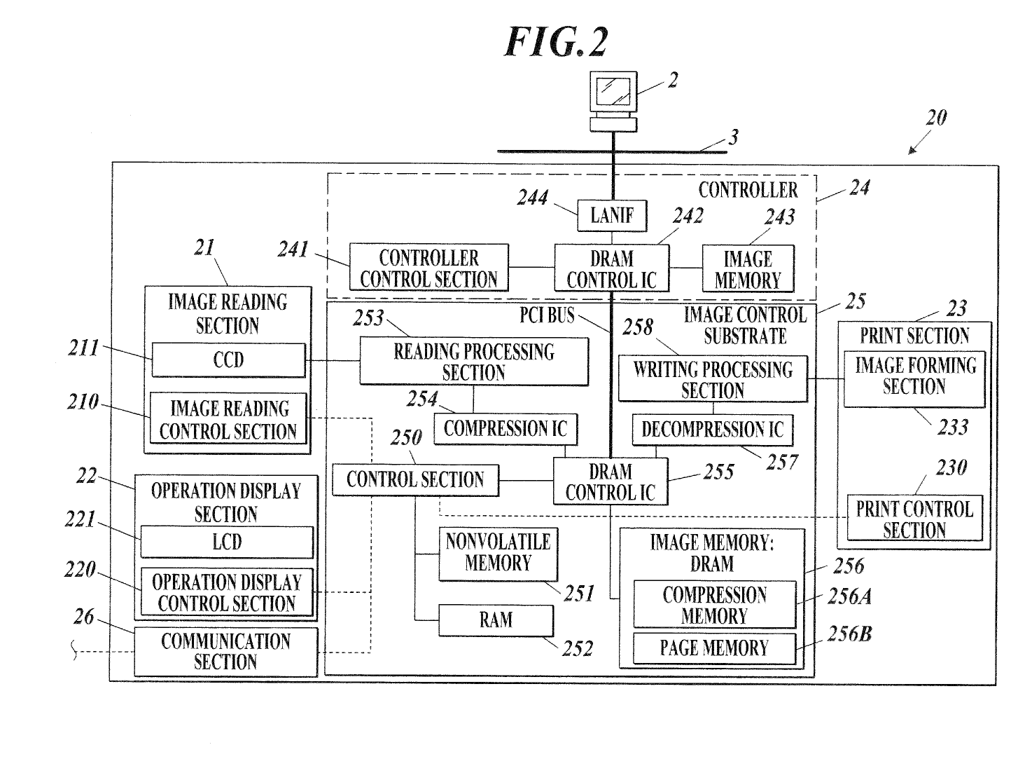

FIG. 2 is a schematic configuration diagram showing the first image forming apparatus 20 according to the present embodiment.

As shown in FIG. 2, the first image forming apparatus 20 includes the image reading section 21, the operation display section 22, the print section 23, the controller 24, an image control substrate 25, a communication section 26, and the like. The first image forming apparatus 20 is connected to an external apparatus 2 on a network 3 via a Local Area Network InterFace (LAN IF) 244 of the controller 24 so that the first image forming apparatus 20 can transmit and receive data to/from the external apparatus 2 in both ways.

The image reading section 21 includes the auto original document feeding section and the reading section described above, and also includes an image reading control section 210. The image reading control section 210 controls the auto original document feeding section, the reading section, and the like, based on a command from the control section 250, thus achieving a scanner function for reading images from a plurality of original documents. Analog image data read by the image reading section 21 is output to a reading processing section 253, and the reading processing section 253 performs A/D conversion and various image processes.

The operation display section 22 includes the LCD 221, the touch panel, and the like, and also includes an operation display control section 220. According to a display signal input from the control section 250, the operation display control section 220 displays various screens for inputting various setting conditions, various processing results, and the like on the LCD. The operation display control section 220 outputs an operation signal, which is input from various types of switches, buttons, a numeric keypad, an operation key group, or a touch panel, to the control section 250.

The print section 23 includes the sections for print output such as the feeding section 231, the sheet conveying section 232, the image forming section 233 for each color, and the fixing section 234 which are described above, and also includes a print control section 230. The print control section 230 controls an operation of each section of the print section 23 such as the image forming section 233 for each color according to the command from the control section 250, and forms an image based on print image data input from a writing processing section 258.

The controller 24 manages and controls data input from the external apparatus 2 connected to the network 3 to the image forming system 1, receives print target data (print data and print setting data) from the external apparatus 2, and transmits print setting data and image data generated by extracting the print data to the image control substrate 25.

The controller 24 includes a controller control section 241, a Dynamic Random Access Memory (DRAM) control integrated circuit (IC) 242, an image memory 243, a LAN IF 244, and the like.

The controller control section 241 centrally controls an operation of each section of the controller 24, and generates image data in a bitmap format by extracting print data input from the external apparatus 2 via the LAN IF 244.

The DRAM control IC 242 controls transfer of the print data received from the LAN IF 244 to the controller control section 241 and writing/reading of the print setting data and the image data to/from the image memory 243. Further, the DRAM control IC 242 is connected with a DRAM control IC 255 of the image control substrate 25 via a Peripheral Components Interconnect (PCI) bus, and according to a command from the controller control section 241, the print setting data and the print target image data is read from the image memory 243, and is output to the DRAM control IC 255.

The image memory 243 is composed of a nonvolatile memory such as DRAM, and temporarily stores the image data and the print setting data.

LAN IF 244 is a communication interface such as a Network Interface Card (NIC) and a modem for connecting to a network 3 such as a LAN, and is configured to receive the print data and the print setting data from the external apparatus 2. The print data and the print setting data thus received is output to the DRAM control IC 242.

The image control substrate 25 includes the control section 250, a nonvolatile memory 251, a Random Access Memory (RAM) 252, the reading processing section 253, a compression IC 254, the DRAM control IC 255, an image memory 256, a decompression IC 257, the writing processing section 258, and the like.

The control section 250 is composed of a Central Processing Unit (CPU) and the like, reads a specified program among system programs and various application programs stored in the nonvolatile memory 251 to expand it in the RAM 252, and executes various processes in cooperation with the program expanded in the RAM 252. Further, the control section 250 centrally controls each section of the first image forming apparatus 20, and centrally manages the entire image forming system.

The control section 250 generates job data and compressed image data based on the image data and the print setting data input via the controller 24 from the external apparatus 2 or based on the image data input from the image reading section 21 and setting information set with the operation display section 22. Then, the control section 250 executes a job in cooperation with the second image forming apparatus 40 based on the job data and the compressed image data thus generated.

The job means a series of operations related to image formation. For example, when generating copies of original documents having predetermined pages, a series of operations related to image formation of the original documents having the predetermined pages is referred to as one job. Such data for executing the operations of the job is job data.

The control section 250 reads a job reception processing program and a job selection processing program according to the present embodiment from the nonvolatile memory 251, and executes job reception processing and job selection processing in cooperation with the read programs and various pieces of data.

In the job reception processing, when a job execution reservation is received by generating job data and compressed image data, whether the received job is executable is determined. When the received job is determined to be executable, the received job is executed. When the received job is determined not to be executable, the received job is registered and managed in a reservation job management table, described below, as a reservation job.

In the job reception processing, a determination as to whether the received job is executable is made according to the state of each of the first and second image forming apparatuses (whether it is in idle state) and according to a job-executable image forming apparatus determined based on output mode information and the finishing presence/absence information set in the received job.

The output mode information indicates either the single-side mode, in which an image is formed on the single side of the sheet, or the both-side mode. The finishing presence/absence information indicates whether the finishing is set for the sheet on which an image is already formed.

In the job selection processing, a reservation job for which the first and second image forming apparatuses operate concurrently is selected among a plurality of reservation jobs registered in the reservation job management table, and the selected reservation job is preferentially executed.

In the job selection processing, as the reservation job to be preferentially executed, a job is selected so that one of the first and second image forming apparatuses in idle state matches a reservation-job-executable image forming apparatus, according to the state of each of the first and second image forming apparatuses (whether it is in idle state) and according to a reservation-job-executable image forming apparatus determined based on the output mode information and the finishing presence/absence information set in the received job.

The nonvolatile memory 251 stores not only various processing programs and various pieces of data related to image formation but also, e.g., the job reception processing program and the job selection processing program according to the present embodiment, and data processed by the various programs.

The RAM 252 forms a work area temporarily storing various programs executed by the control section 250, various pieces of data related to these programs, and the like.

The RAM 252 temporarily stores job data generated by the control section 250 based on the image data and the print setting data input from the controller 24, or based on the image data input from the image reading section 21 and the setting information set with the operation display section 22 when the image data is obtained.

In addition, the RAM 252 functions as a memory section for storing the reservation job management table and execution job management data generated by the control section 250.

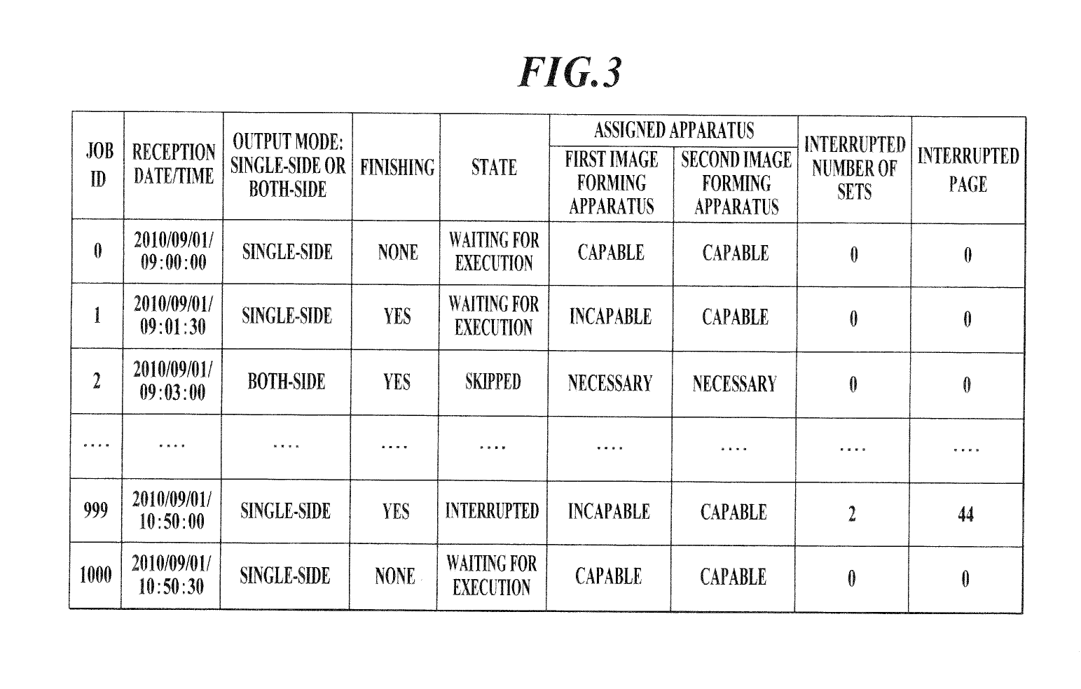

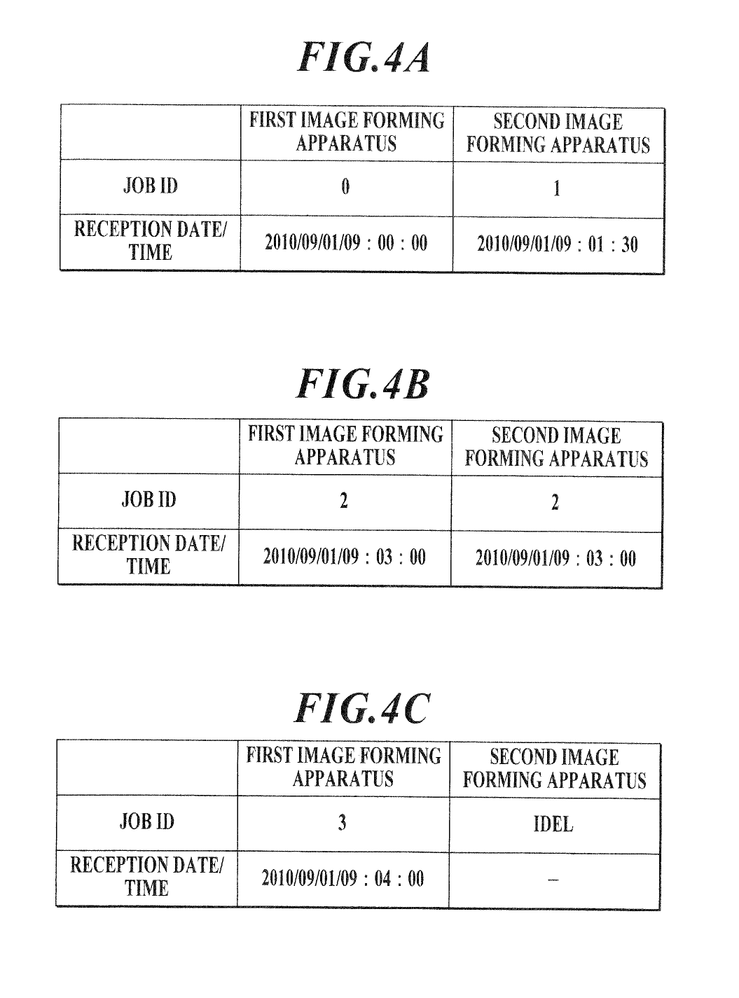

FIG. 3 shows an example of a reservation job management table, and FIG. 4 shows an example of execution job management data.

As shown in FIG. 3, the reservation job management table includes items such as “job ID”, “reception date/time”, “output mode”, “finishing”, “state”, “assigned apparatus”, “interrupted number of sets”, and “interrupted page” for each reservation job.

The “job ID” is a circulating number for identifying a reservation job.

The “reception date/time” is date/time information (year, month, day, hour, minute, second, and the like) at which execution reservation of a reservation job is received.

The “output mode” represents output mode information set in job data of the reservation job, and represents whether the mode is the single-side mode, in which the image is formed on the single side of the sheet, or the both-side mode.

The “finishing” indicates finishing presence/absence information set in the job data of the reservation job, and indicates whether finishing is performed on a sheet on which an image is already formed.

The “state” indicates a state of a reservation job, i.e., a state of waiting for execution, being skipped, or being interrupted. The waiting for execution is a state in which the reservation job is kept waiting without being executed. The skipped state is a state in which execution order is skipped by executing the reservation job having a reception date/time later than that of the reservation job in question before executing the reservation job in question. The interrupted state is a state in which a temporary halt of execution (interruption) and execution order is skipped by executing the reservation job having the reception date/time later than that of the reservation job in question before executing the reservation job in question. Hereinafter, the reservation job whose “state” is the skipped state or interrupted state is also referred to as a skipped job.

The “assigned apparatus” means the job-executable image forming apparatus or necessary image forming apparatus for job execution, and is determined based on the output mode information and the finishing presence/absence information set in the job data of the reservation job.

In the present embodiment, when the reservation job is to be performed in the single-side mode and requires no finishing, each of the first image forming apparatus and the second image forming apparatus is the image forming apparatus (reservation-job-executable image forming apparatus) capable of executing the reservation job. Accordingly, “capable” is shown in each of the fields of the “first image forming apparatus” and the “second image forming apparatus” of the “assigned apparatus”.

When the reservation job is to be performed in the single-side mode and requires finishing, the second image forming apparatus is the image forming apparatus (reservation-job-executable image forming apparatus) capable of executing the reservation job. Accordingly, “incapable” is shown in the field of the “first image forming apparatus” and “capable” is shown in the field of the “second image forming apparatus” of the “assigned apparatus”.

When the reservation job is to be performed in the both-side mode, each of the first image forming apparatus and the second image forming apparatus is the image forming apparatus (reservation-job-executable image forming apparatus) capable of executing the reservation job, and the necessary image forming apparatus for executing the reservation job. Accordingly, “necessary” is shown in each of the fields of the “first image forming apparatus” and the “second image forming apparatus” of the “assigned apparatus”.

The “interrupted number of sets” indicates the number of sets which have already been output when the reservation job whose “state” is interruption is interrupted. The “interrupted page” indicates a page number of a last page among already-output pages when the reservation job whose “state” is interruption is interrupted.

As shown in FIGS. 4A-4C, the execution job management data shows jobs executed by the first and second image forming apparatuses. The “job ID” and the “reception date/time” of the job (execution job) which is being executed are registered in the execution job management data. It is shown that the image forming apparatus for which the job is registered in the execution job management data as shown in FIGS. 4A-4C is in an operating state in order to execute the registered jobs. It is shown that that the image forming apparatus for which no job is registered is in a waiting state.

FIG. 4A indicates that each of the first and second image forming apparatuses executes a different job from each other. FIG. 4B indicates that the first and second image forming apparatuses execute the same job, i.e., the job performed in the both-side mode. FIG. 4C indicates that the first image forming apparatus executes a job having a job ID 3, and the second image forming apparatus is in waiting state (IDLE).

The reading processing section 253 performs various processes to analog image data input from the image reading section 21 such as analog processing, A/D conversion processing, shading processing, and thereafter generates digital image data. The generated image data is output to the compression IC 254.

The compression IC 254 applies compression processing to input digital image data and outputs it to the DRAM control IC 255.

The DRAM control IC 255 controls compression processing of image data performed by the compression IC 254 and decompression processing of compressed image data performed by the decompression IC 257 according to the command from the control section 250, and controls input/output of image data to/from the image memory 256.

For example, when the DRAM control IC 255 receives a save command of image data read by the image reading section 21 from the control section 250, the DRAM control IC 255 causes the compression IC 254 to execute compression processing of the image data input to the reading processing section 253, and saves compressed image data to the compression memory 256A of the image memory 256. When the DRAM control IC 255 receives image data from the DRAM control IC 242 of the controller 24, the DRAM control IC 255 causes the compression IC 254 to execute compression processing of the image data, and stores compressed image data in the compression memory 256A of the image memory 256.

Further, when the DRAM control IC 255 receives a print output command of compressed image data stored in the compression memory 256A from the control section 250, the DRAM control IC 255 reads the compressed image data from the compression memory 256A, and causes the decompression IC 257 to perform decompression processing and store the decompressed image data in a page memory 256B. Further, when the DRAM control IC 255 receives a print output command of image data stored in the page memory 256B, the DRAM control IC 255 reads the image data from the page memory 256B and outputs the image data to the writing processing section 258.

The image memory 256 includes the compression memory 256A and the page memory 256B each of which is composed of Dynamic RAM (DRAM). The compression memory 256A is a memory for storing compressed image data. The page memory 256B is a memory for temporarily storing image data for print output.

The decompression IC 257 performs decompression processing on compressed image data.

The writing processing section 258 generates print image data for image formation based on image data input from the DRAM control IC 255, and outputs the print image data to the print section 23.

The communication section 26 is a communication interface for connecting to a network to which each apparatus constituting the image forming system 1 is connected, and transmits and receives various pieces of data to/from each apparatus.

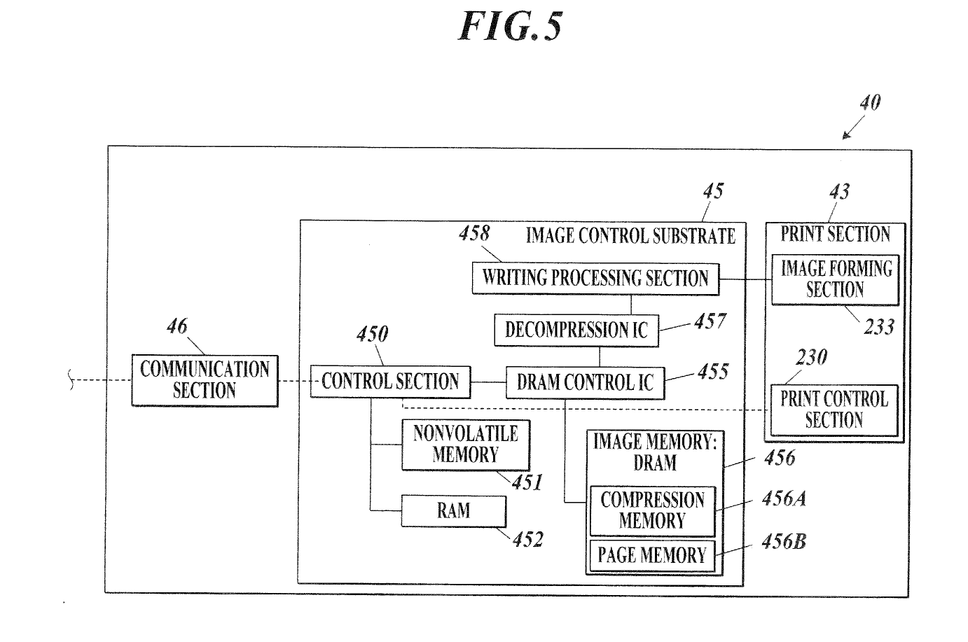

FIG. 5 shows a schematic configuration diagram of the second image forming apparatus 40 according to the present embodiment.

As shown in FIG. 5, the second image forming apparatus 40 includes a print section 43, an image control substrate 45, a communication section 46, and the like.

The print section 43 is the same as the print section 23 of the first image forming apparatus 20. The same portions of the print section 43 as those of the print section 23 are denoted with the same reference numerals, and description thereabout will not be repeated.

The image control substrate 45 includes a control section 450, a nonvolatile memory 451, a RAM 452, a DRAM control IC 455, an image memory 456A decompression IC 457, a writing processing section 458, and the like.

The control section 450 is composed of a Central Processing Unit (CPU) and the like, reads a specified program from among system programs and various application programs stored in the nonvolatile memory 451 to expand it in the RAM 452, and executes various processes in cooperation with the program expanded in the RAM 452. Further, the control section 450 centrally controls each section of the second image forming apparatus 40.

The control section 450 executes a job based on job data of the job received from the first image forming apparatus and compressed image data.

The nonvolatile memory 451 stores not only various processing programs and various pieces of data related to image formation but also, e.g., data processed by the various programs.

The RAM 452 forms a work area temporarily storing various programs to be executed by the control section 450, various pieces of data related to these programs, and the like.

Further, the RAM 452 temporarily stores job data input from the first image forming apparatus 20 via the communication section 46.

The DRAM control IC 455 controls the decompression IC 457 in decompression processing of compressed image data according to a command from the control section 450, and controls input/output of image data to/from the image memory 456.

For example, when the DRAM control IC 455 receives job data and compressed image data from the communication section 46, the DRAM control IC 455 stores the job data in the RAM 452 and stores the compressed image data in the compression memory 456A of the image memory 456.

Further, when the DRAM control IC 455 receives a print output command of compressed image data stored in the compression memory 456A from the control section 450, the DRAM control IC 455 reads the compressed image data from the compression memory 456A, and causes the decompression IC 457 to perform decompression processing and store the decompressed image data in a page memory 456B. Further, when the DRAM control IC 455 receives a print output command of image data stored in the page memory 456B, the DRAM control IC 455 reads the image data from the page memory 456B and outputs the image data to the writing processing section 458.

The image memory 456 includes the compression memory 456A and the page memory 456B each of which is composed of Dynamic RAM (DRAM). The compression memory 456A is a memory for storing compressed image data. The page memory 456B is a memory for temporarily storing image data for print output.

The decompression IC 457 performs decompression processing on compressed image data.

The writing processing section 458 generates print image data for image formation based on image data input from the DRAM control IC 455, and outputs the print image data to the print section 43.

The communication section 46 is a communication interface for connecting to a network to which each apparatus constituting the image forming system 1 is connected, and transmits and receives various pieces of data to/from each apparatus.

Subsequently, an operation of the present embodiment will be described.

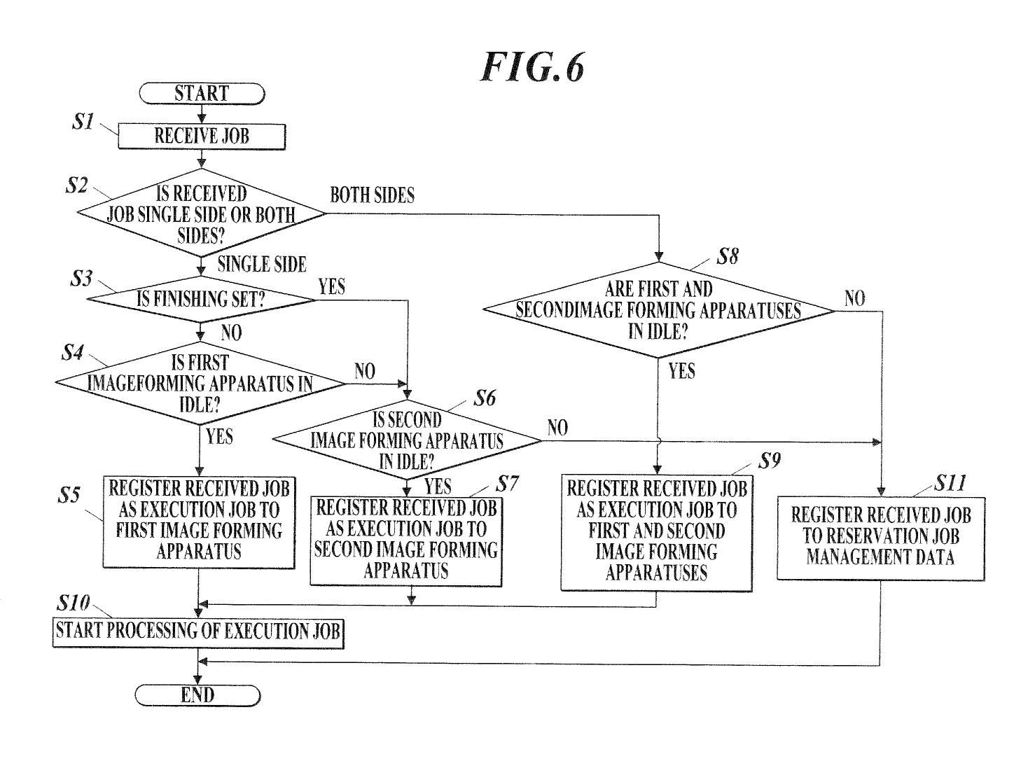

FIG. 6 shows a flowchart of the job reception processing executed by the first image forming apparatus 20. The job reception processing shown in FIG. 6 is executed while the control section 250 and each section cooperate with each other.

First, the control section 250 receives the execution reservation of the job by generating the job data (step S1), and refers to the job data of the received job to determine whether the received job is to be performed in the single-side mode or both-side mode (step S2).

When the received job is to be performed in the single-side mode (step S2; single side), the control section 250 determines whether finishing is set in the received job (step S3). When on finishing is set in the received job (step S3; NO), the control section 250 refers to the execution job management data to determine whether the state of the first image forming apparatus is waiting state (IDLE) (step S4).

When the state of the first image forming apparatus is in waiting state (IDLE) (step S4; YES), the control section 250 registers, to the execution job management data, the received job as the execution job for the first image forming apparatus (step S5).

When finishing is set in the received job (step S3; YES), or the state of the first image forming apparatus is not in waiting state (IDLE) (step S4; NO), the control section 250 refers to the execution job management data to determine whether the state of the second image forming apparatus is in waiting state (IDLE) (step S6).

When the state of the second image forming apparatus is in waiting state (IDLE) (step S6; YES), the control section 250 registers, to the execution job management data, the received job as the execution job for the second image forming apparatus (step S7).

When the received job is to be performed in the both-side mode (step S2; both sides), the control section 250 refers to the execution job management data to determine whether each state of the first image forming apparatus and the second image forming apparatus is in waiting state (IDLE) (step S8).

When each state of the first image forming apparatus and the second image forming apparatus is in waiting state (IDLE) (step S8; YES), the control section 250 registers, to the execution job management data, the received job as the execution job for each of the first image forming apparatus and the second image forming apparatus (step S9).

After step S5, step S7 or step S9, the control section 250 starts execution processing of the execution job registered in the execution job management data (step S10), and terminates the job reception processing.

When the state of the second image forming apparatus is not in waiting state (IDLE) (step S6; NO), or each state of the first image forming apparatus and the second image forming apparatus is not in waiting state (IDLE) (step S8; NO), the control section 250 registers the received job to the reservation job management data (step S11), and terminates the job reception processing.

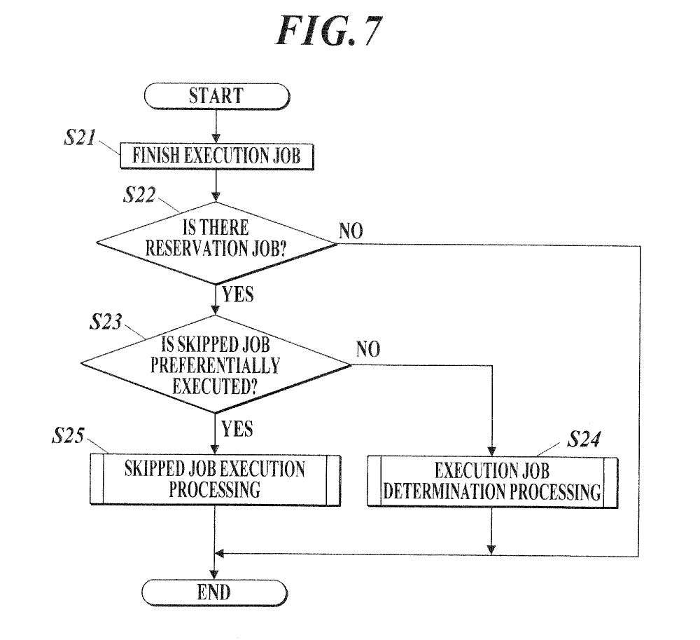

FIG. 7 shows a main flowchart of the job selection processing executed by the first image forming apparatus 20. The job selection processing shown in FIG. 7 is executed while the control section 250 and each section cooperate with each other.

When the processing of the execution job ends (step S21), the control section 250 determines whether the reservation job management table includes the reservation job (step S22). When the reservation job management table includes no reservation job (step S22; NO), the control section 250 terminates the job selection processing.

When the reservation job management table includes the reservation job (step S22; YES), the control section 250 determines whether there is a setting for preferentially execute the reservation job (skipped job) whose “state” is the skipped state or interrupted state in the reservation job management table (step S23).

The setting of preferential execution of the skipped job in step S23 is set in advance when the image forming system is shipped, or set in advance when a user manipulates the operation display section 22.

When there is no setting for preferentially executing the skipped job (step S23; NO), the control section 250 executes the execution job determination processing (step S24), and terminates the job selection processing. When there is a setting for preferentially executing the skipped job (step S23; YES), the control section 250 executes a skipped job execution processing (step S25), and terminates the job selection processing.

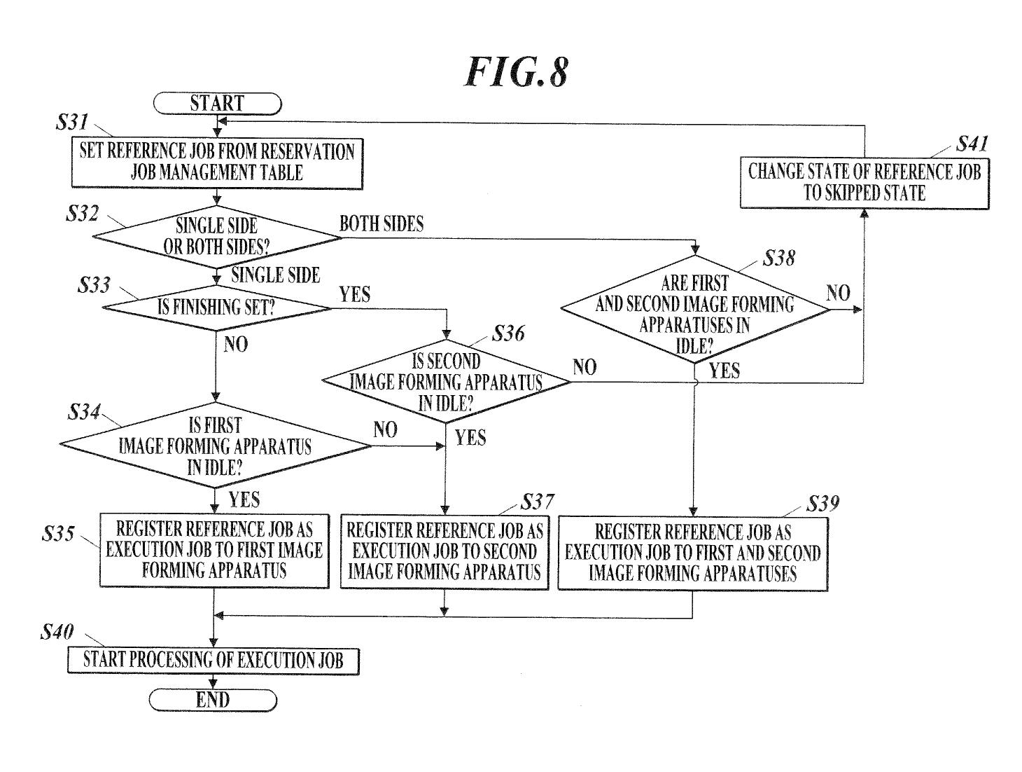

FIG. 8 shows a flowchart of the execution job determination processing executed in step S24. The execution job determination processing shown in FIG. 8 is executed while the control section 250 and each section cooperate with each other.

The control section 250 refers to the reservation job management table to select the latest reservation job which has not yet been referred to and has a reception date/time closest to the current date/time among the registered reservation jobs, and sets the selected reservation job as a reference job (step S31). Then, the control section 250 refers to the “output mode” of the reference job, and determines whether the reference job is to be performed in the single-side mode or both-side mode (step S32).

When the reference job is to be performed in the single-side mode (step S32; single side), the control section 250 refers to the “finishing” of the reference job to determine whether finishing is set in the reference job (step S33). When no finishing is set in the reference job (step S33; NO), the control section 250 refers to the execution job management data to determine whether the state of the first image forming apparatus is in waiting state (IDLE) (step S34).

When the state of the first image forming apparatus is in waiting state (IDLE) (step S34; YES), the control section 250 registers, to the execution job management data, the reference job as the execution job for the first image forming apparatus, and deletes data of the reference job from the reservation job management table (step S35).

When finishing is set in the reference job (step S33; YES), or when the state of the first image forming apparatus is not in waiting state (IDLE) (step S34; NO), the control section 250 refers to the execution job management data to determine whether the state of the second image forming apparatus is in waiting state (IDLE) (step S36).

When the state of the second image forming apparatus is in waiting state (IDLE) (step S36; YES), the control section 250 registers, to the execution job management data, the reference job as the execution job for the second image forming apparatus, and deletes data of the reference job from the reservation job management table (step S37).

When the reference job is to be performed in the both-side mode (step S32; both sides), the control section 250 refers to the execution job management data to determine whether each state of the first image forming apparatus and the second image forming apparatus is in waiting state (IDLE) (step S38).

When each state of the first image forming apparatus and the second image forming apparatus is in waiting state (IDLE) (step S38; YES), the control section 250 registers, to the execution job management data, the reference job as the execution job for each of the first image forming apparatus and the second image forming apparatus, and deletes data of the reference job from the reservation job management table (step S39).

After step S35, step S37 or step S39, the control section 250 starts execution processing of the reference job registered in the execution job management data as the execution job (step S40), and terminates the job execution processing.

When the state of the second image forming apparatus is not in waiting state (IDLE) (step S36; NO), or when each state of the first image forming apparatus and the second image forming apparatus is not in waiting state (IDLE) (step S38; NO), the control section 250 sets the “state” of the reference job to the skipped state in the reservation job management table (step S41), and returns back to the processing of step S31.

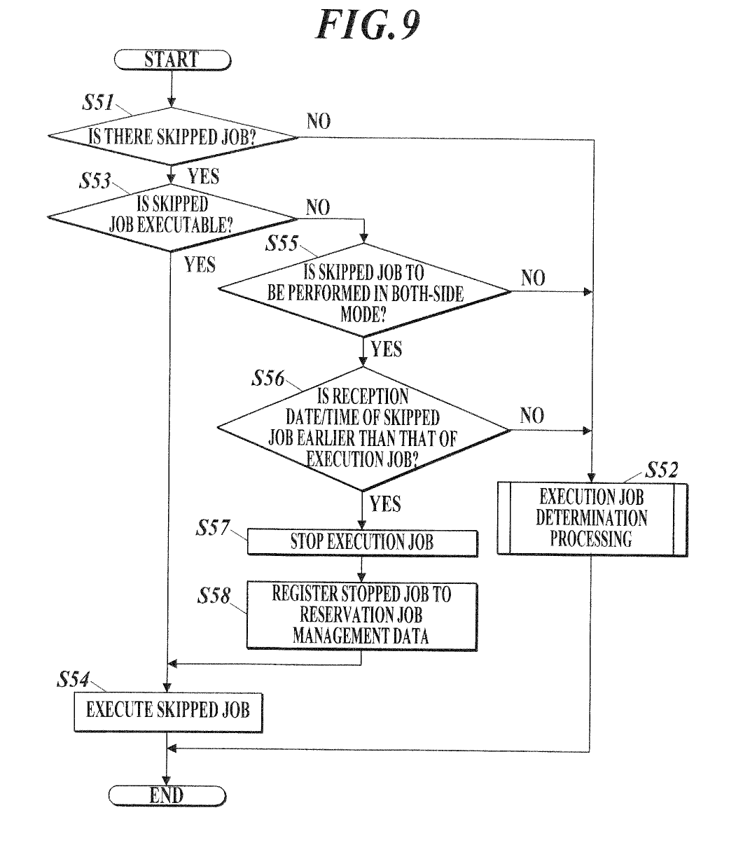

FIG. 9 shows a flowchart of the skipped job execution processing executed in step S25. The skipped job execution processing shown in FIG. 9 is executed while the control section 250 and each section cooperate with each other.

The control section 250 successively refers to the reservation jobs in order of closeness of the reception date/time to the current date/time in such a manner that a reversed job having a reception date/time closer to the current date/time is referred to first in the reservation job management table, and determines whether there is skipped job whose “state” is the skipped state or interrupted state (step S51). When there is no such skipped job (step S51; NO), the execution job determination processing is executed (step S52), and the skipped job execution processing is terminated.

Where there is such skipped job (step S51; YES), the control section 250 determines whether the skipped job is executable (step S53).

In step S52, the control section 250 refers to the “assigned apparatus” of the skipped job to determine whether the image forming apparatus set as “capable” or “necessary” matches the image forming apparatus indicated as being in waiting state (IDLE) in the execution job management data. When the image forming apparatus set as “capable” or “necessary” matches the image forming apparatus indicated as being in waiting state (IDLE) in the execution job management data, the skipped job is determined to be executable.

When the skipped job is executable (step S53; YES), the control section 250 registers, to the execution job management data, the skipped job as the execution job, deletes it from the reservation job management data, starts execution of the skipped job registered as the execution job (step S54), and terminates the skipped job execution processing.

When the “state” of the skipped job registered as the execution job is the interrupted state in step S54, execution of the job is resumed from the page and the number of sets indicated by the “interrupted number of sets” and the “interrupted page”.

When the skipped job is not executable (step S53; NO), the control section 250 refers to the “output mode” of the skipped job to determine whether the skipped job is to be performed in the both-side mode (step S55).

When the skipped job is to be executed in the both-side mode (step S55; YES), the control section 250 determines whether the reception date/time of the skipped job is earlier than the reception date/time of the execution job registered in the image forming apparatus (in this case, first and second image forming apparatuses) necessary for executing the skipped job by referring to the execution job management data (step S56).

When the reception date/time of the skipped job is earlier than the reception date/time of the execution job (step S56; YES), the control section 250 stops the execution job, and deletes the execution job from the execution job management data (step S57). Then, the stopped execution job (stopped job) is registered to the reservation job management table (step S58), and the processing of step S54 is subsequently performed.

In step S58, the stopped job is registered as the reservation job for which the “state” is set to the interrupted state, the “interrupted number of sets” is set to the number of sets when stopped, and the “interrupted page” is set to the page number of the last page among already-output pages when stopped.

In the present embodiment, the skipped job is determined to be unexecutable in step S53. Accordingly, the job whose execution is finished in step S21 is a job executed in one of the first image forming apparatus and the second image forming apparatus, i.e., a job performed in the single-side mode. Therefore, by steps S53 to S58, when execution of the job in the single-side mode is finished, the control section 250 stops execution of a job in the single-side mode currently executed by the other of the image forming apparatuses, so that the skipped job performed in the both-side mode is preferentially executed.

When the skipped job is not to be performed in the both-side mode (step S55; NO), or when the reception date/time of the skipped job is later than the reception date/time of the execution job (step S56; NO), the control section 250 proceeds to the processing of step S52 (execution job determination processing), and terminates the skipped job execution processing.

As described above, according to the present embodiment, the reservation job for which the image forming apparatuses (first and second image forming apparatuses) operate concurrently can be preferentially executed. Therefore, the overall execution efficiency of the jobs can be improved, and productivity can be enhanced.

In particular, as the reservation job to be preferentially executed, the reservation job for which the image forming apparatuses in waiting state matches the image forming apparatus whose “assigned apparatus” of the reservation job is set to be capable or necessary can be selected, according to each state (whether it is in waiting state) of the first and second image forming apparatuses managed by the execution job management data, and the “assigned apparatus” indicating the image forming apparatus which can or need to execute the reservation job determined based on the “output mode” and the “finishing” managed in the reservation job management table. Therefore, the job which is executable in the image forming apparatus in waiting state can be preferentially executed, and this solves reduction of the processing efficiency due to occurrence of the image forming apparatus in waiting state.

In the case where there is the skipped job in the both-side mode whose execution order is skipped so that the reservation job whose reception date/time is later than that of the reservation job in question is executed prior to the reservation job in question, when there is the image forming apparatus which has finished execution of the job in the single-side mode, the skipped job can be preferentially executed by interrupting the job currently executed by the other image forming apparatus.

Since one of the first and second image forming apparatuses has the control section for executing the job reception processing and the job selection processing and the RAM for storing the reservation job management table and the execution job management data, one of the first and second image forming apparatuses can perform selection control (job reception processing and job selection processing) of the preferentially executed reservation job.

In the above description, a case where the nonvolatile memory 251 is used as a computer-readable medium for the program according to the present invention is disclosed, but the present invention is not limited thereto. As other computer-readable media, a nonvolatile memory such as flash memory and a portable storage medium such as a Compact Disc Read Only Memory (CD-ROM) can be applied. In addition, as a medium to provide data of the program of the present invention through communication lines, a carrier wave can be applied to the present invention.

It should be noted that the image forming system 1 according to the present embodiment may be an image forming apparatus integrally formed with the feeding apparatus, the first image forming apparatus, the second image forming apparatus, and the finishing apparatus.

The present invention is not limited to the contents of the above described embodiment, and can be modified without deviating from the gist of the present invention as necessary.

According to one aspect of the preferred embodiment of the present invention, there is provided an image forming system of a series-connected tandem configuration including a plurality of image forming apparatuses connected in series, in which when a job in a both-side mode in which images are formed on both sides of a sheet is executed, one of the image forming apparatuses forms an image on one side of the sheet, and an image forming apparatus different from the image forming apparatus forming the image on the one side forms an image on the other side of the sheet, the image forming system comprising: a control section for managing execution of a job of each of the image forming apparatuses, receiving an execution reservation of each of a plurality of jobs, managing the received jobs as reservation jobs, selecting a reservation job for which the image forming apparatuses operate concurrently among the reservation jobs, and preferentially executing the selected reservation job.

According to the present embodiment, the reservation job for which the image forming apparatuses (for example, first and second image forming apparatuses) operate concurrently can be preferentially executed. Therefore, the overall execution efficiency of the plurality of jobs can be improved, and productivity can be enhanced.

Preferably, the control section selects, as a preferentially executed reservation job, a reservation job for which an image forming apparatus in waiting state among the image forming apparatuses matches an image forming apparatus capable of executing the reservation job determined based on output mode information indicating either a single-side mode in which an image is formed on a single side of the sheet or the both-side mode, and based on finishing presence/absence information indicating whether finishing is set for the sheet on which the image is already formed, the output mode information and the finishing presence/absence information being set in the reservation job.

According to the present embodiment, the job that can be executed by the image forming apparatus in waiting state can be preferentially executed, and this solves reduction of the processing efficiency due to occurrence of the image forming apparatus in waiting state.

Preferably, the control section manages the reservation jobs by attaching date/time information at which the execution reservation is received for each of the reservation jobs, and when there is a skipped job, in the reservation jobs, whose execution order is skipped so that a reservation job whose reception date/time is later than the reception date/time of the skipped job is executed prior to the skipped job, and when the skipped job is a job in the both-side mode, the skipped job is selected as the preferentially executed reservation job by interrupting a currently-executed job.

According to the present embodiment, when a reservation job whose reception date/time is later than the reception date/time of a reservation job in question is executed earlier, which makes a skipped job in the both-side mode whose execution order is skipped, the skipped job can be preferentially executed.

Preferably, when there is an image forming apparatus, in the image forming apparatuses, in which execution of a job in a single-side mode is finished, the control section selects the skipped job as the preferentially executed reservation job.

According to the present embodiment, the skipped job can be preferentially executed by interrupting a job being executed by the other image forming apparatus when there is an image forming apparatus that has finished execution of the job in the single-side mode.

Preferably, the image forming system further comprises a memory section for storing a reservation job management table for managing information related to each of the reservation jobs and execution job management data for managing a job executed in each of the image forming apparatuses.

According to the present embodiment, the reservation job in which the image forming apparatus in waiting state matches the image forming apparatus in which the “assigned apparatus” of the reservation job is “capable” or “necessary” can be selected as a preferentially executed reservation job according to each of the states of the first and second image forming apparatuses managed by the execution job management data (whether it is in waiting state) and the “assigned apparatus” indicating the image forming apparatus that can or need to execute the reservation job determined based on the “output mode” and the “finishing” managed in the reservation job management table. Therefore, the job that can be executed in the image forming apparatus in waiting state can be preferentially executed. Therefore, the overall execution efficiency of the plurality of jobs can be improved, and productivity can be enhanced.

Preferably, one of the image forming apparatuses has the control section and the memory section.

According to the present embodiment, one of the first and second image forming apparatuses can perform selection control (job reception processing and job selection processing) of a preferentially executed reservation job.

The present U.S. patent application claims a priority under the Paris Convention of Japanese patent application No. 2010-230182 filed on Oct. 13, 2010, in which all contents of this application are disclosed, and which shall be a basis of correction of an incorrect translation.

What is claimed is:

1. An image forming system of a series-connected tandem configuration including a plurality of image forming apparatuses connected in series, in which when a job in a both-side mode in which images are formed on both sides of a sheet is executed, one of the image forming apparatuses forms an image on one side of the sheet, and an image forming apparatus different from the image forming apparatus forming the image on the one side forms an image on the other side of the sheet, the image forming system comprising:
a control section for managing execution of a job of each of the image forming apparatuses, receiving an execution reservation of each of a plurality of jobs, managing the received jobs as reservation jobs, selecting a reservation job for which the image forming apparatuses operate concurrently among the reservation jobs, and preferentially executing the selected reservation job.

2. The image forming system of claim 1, wherein the control section selects, as a preferentially executed reservation job, a reservation job for which an image forming apparatus in waiting state among the image forming apparatuses matches an image forming apparatus capable of executing the reservation job determined based on output mode information indicating either a single-side mode in which an image is formed on a single side of the sheet or the both-side mode, and based on finishing presence/absence information indicating whether finishing is set for the sheet on which the image is already formed, the output mode information and the finishing presence/absence information being set in the reservation job.

3. The image forming system of claim 1, wherein
the control section manages the reservation jobs by attaching date/time information at which the execution reservation is received for each of the reservation jobs, and
when there is a skipped job, in the reservation jobs, whose execution order is skipped so that a reservation job whose reception date/time is later than the reception date/time of the skipped job is executed prior to the skipped job, and when the skipped job is a job in the both-side mode, the skipped job is selected as the preferentially executed reservation job by interrupting a currently-executed job.

4. The image forming system of claim 3, wherein when there is an image forming apparatus, in the image forming apparatuses, in which execution of a job in a single-side mode is finished, the control section selects the skipped job as the preferentially executed reservation job.

5. The image forming system of claim 1, further comprising a memory section for storing a reservation job management table for managing information related to each of the reservation jobs and execution job management data for managing a job executed in each of the image forming apparatuses.

6. The image forming system of claim 5, wherein one of the image forming apparatuses has the control section and the memory section.
